(19) United States
(12) Patent Application Publication
(10) Pub. No.: US 2008/0038686 A1
(43) Pub. Date: Feb. 14, 2008

(54) Methods and kits for early stage caries detection

(76) Inventor: Shigemi Nagai, Lexington, MA (US)

Correspondence Address: Sonia K. Guterman, Suite 345, 88 Black Falcon Avenue, Boston, MA, 02210-2481, US

(21) Appl. No.: 11/787,158

(22) Filed: Apr. 13, 2007

Related U.S. Application Data
(60) Provisional application No. 60/792,768, filed on Apr. 18, 2006.
(60) Provisional application No. 60/819,135, filed on Jul. 7, 2006.
(60) Provisional application No. 60/901,421, filed on Feb. 15, 2007.
(60) Provisional application No. 60/850,922, filed on Oct. 11, 2006.

(51) Int. Cl. A61C 19/06

(52) U.S. Cl. 433/29

(57) ABSTRACT

Methods and kits are provided for identifying very early stage carious lesions using a detectable probe that binds to the lesion.

### RELATED APPLICATIONS

The present application is related to provisional applications having Ser. Nos. 60/792,768, 60/819,135, 60/850,922, and 60/901,421 filed in the U.S. Patent and Trademark Office respectively on Apr. 18, 2006, Jul. 7, 2006, Oct. 11, 2006 and Feb. 15, 2007, each of which is hereby incorporated by reference herein in its entirety.

### TECHNICAL FIELD

The invention herein relates to detection of caries at an early stage using compositions that bind preferentially to the caries, and the pre-carious lesions are detected either by absorption of light in the near infra-red wavelength range or by luminescence using a hand held probe for a spectrophotometer or another optical device, by fluorescence using a UV lamp, or by fluorescence detected circular dichroism.

### BACKGROUND

Despite the positive effects of preventive measures to reduce caries primarily through the application of fluoride in various ways, caries along with periodontal disease remain the main reason for tooth loss worldwide. If detected early, i.e. before the demineralization of the tooth surface has reached the dentin, an insipient caries lesion can be cured by remineralization.

If however the lesion has progressed into the dentin, restorative procedures such as placing amalgam or composite fillings become necessary. Such restorative procedures are in general more invasive and represent a much greater expense to a patient or a third party provider. Thus, early detection of carious lesions is a key element in the prevention and treatment of dental caries.

In the first half of the 20^{th} century, indices and methods of conducting surveys for the level of dental disease were developed. Modern epidemiological studies began during the decade of the 1950s, and many reliable studies have been conducted after 1960. ORCA was among the first scientific forums to focus on the challenges of diagnosing caries in populations with low rates of lesion progression. The concluding remarks of the Symposium of the ORCA Caries Diagnosis Working Group state that, “the development of methods for determining whether a carious lesion is stable or progressing is a priority in caries research.”

The rather poor diagnostic performance of conventional caries detection methods has prompted the research community to develop quantitative detection methods, such as electrical conductance measurements, light scattering methods, and laser fluorescence methods, in addition to the X-ray technique which is the current standard. There are at least three motivations for this development: (1) quantitative methods may detect lesions at an earlier stage than conventional methods; (2) quantitative measurements are more reliable than qualitative measurements, and (3) quantitative assessments may provide the means for monitoring the course of disease in a way that is non-detrimental to the patient.

However, a systematic review of diagnostic methods prepared for the 2001 National Institutes of Health Consensus Development Conference on ‘Diagnosis and Management of Dental Caries through Life’ was unable to establish relative efficacies of various methods currently used to detect dental caries.

### SUMMARY

In one aspect, the invention provides a method for detecting early dental caries in a subject, the method including, contacting a caries lesion at an early stage by selective binding an optically detectable probe to the caries, and detecting the caries having bound probe, by using an optical device. In certain embodiments, the early stage caries is at a stage that is prior to demineralization, i.e., the caries is a “white spot” or an incipient and/or early stage of caries.

In certain embodiments of the method herein, detecting the selective binding further includes a step of contacting a tooth with a fluorescent probe, and the fluorescent probe is selected from the group of tetracycline, Hylight Fluor, Qdot, Indocyanine Green, Doxorubicin, Riboflavin, Chlorophyll and Porphyrin, and illuminating the tooth at an excitation wavelength, in which embodiment the method includes diagnosing by detecting an area of light emission at an emission wavelength. In an alternative embodiment of the method, detecting the selective binding further includes a step of contacting the tooth with the probe, and the probe is a chemoluminescent substrate such as luminal and luciferin, and the method further includes contacting the tooth with the other reactants such as hydrogen peroxide, luciferase and metal ions as catalysts, in which diagnosing is detecting an area of luminenesce.

In yet another alternative embodiment of the method, detecting the selective binding further includes a step of contacting the tooth with a colloidal gold, and diagnosing is detecting an area of absorbance of near infra red (NIR) light. In another alternative embodiment of the method, detecting the selective binding further includes a step of contacting the tooth with a quantum dot composition probe, and diagnosing is detecting luminescence or fluorescence dichroism. In yet another alternative embodiment of the method, detecting the selective binding further includes a step of contacting a tooth with a probe that is a conjugate of a quantum dot composition, and the conjugate is attached to a second agent selected from the group of a tetracycline, bismuth, a colloidal gold or the like, followed by detecting fluorescence or fluorescence dichroism. In another alternative embodiment of the method, detecting the selective binding further includes a step of contacting a tooth with colloidal gold, and diagnosing is detecting fluorescence with a HiLyte Fluor 750 hydrazide.

In another embodiment of the method, the optically detectable probe is charged and the probe binds the early stage caries by electrovalent bond. In another embodiment of the method, detecting the caries is observing by photometry. In another embodiment, the probe is tetracycline and detecting the caries with selectively bound tetracycline probe is observing a white spot. In yet another embodiment, the caries with the selectively bound quantum dot probe is a spot of enamel-translucent fluorescence. In another embodiment of the method, a white spot is diagnosed on the surface of enamel, or within an underlayer of about 50 to about 100 micrometer of the surface.

In another embodiment of the method, the fluorescent probe is a tetracycline, the wavelength for illuminating the tooth is about 350 to about 450 nm, and the wavelength for detecting its fluorescence is about 450 to about 600 nm. In yet another embodiment of the method, the fluorescent probe is a Hilyte Fluor, the wavelength for illuminating the tooth is about 720 to about 750 nm, and the wavelength for detecting its fluorescence is about 750 to about 800 nm. In still another related embodiment of the method, the fluorescence probe is a Qdot, the wavelength for illuminating the tooth is about 400 to about 750 nm, and the wavelength for detecting its fluorescence is about 750 to about 900 nm. In another related embodiment of the method, the fluorescence probe is an Indocyanine Green, the wavelength for illuminating the tooth is about 750 to about 800 nm, and the wavelength for detecting its fluorescence is about 820 to about 870 nm. In another related embodiment of the method, the fluorescence probe is a Doxorubicin, the wavelength for illuminating the tooth is about 400 to about 500 nm, and the wavelength for detecting its fluorescence is about 600 to about 700 nm. In yet another related embodiment of the method, the fluorescence probe is a Riboflavin, the wavelength for illuminating the tooth is about 400 to about 500 nm, and the wavelength for detecting its fluorescence is about 500 to about 700 nm. In another related embodiment of the method, the fluorescence probe is a Chlorophyll A, the wavelength for illuminating the tooth is about 600 to about 650 nm, and the wavelength for detecting its fluorescence is about 670 to about 900 nm. In yet another related embodiment of the method, the fluorescence probe is a Porphyrin, the wavelength for illuminating the tooth is about 550 to about 650 nm, and the wavelength for detecting its fluorescence is about 650 to about 750 nm.

In another embodiment of the method, the probe includes a luciferase, luciferin and ATP, in which the wavelength for detecting its bioluminescence is about 600 to about 800 nm. In another related embodiment of the method, the probe is a colloidal gold, and the wavelength for detecting an area of its absorbance is about 500 to about 800 nm. In still another related embodiment of the method, the probe is a bismuth, and the wavelength for detecting an area of its absorbance is about 500 to about 800 nm.

In certain embodiments, the caries is interproximal. In another embodiment, prior to contacting, interproximal regions are accessed by at least one method selected from the group of: inserting a spacer; and delivering the probe into the interproximal area using a metal or plastic strip containing the probe.

In certain embodiments of the method, the probe is a conjugate having a quantum dot composition or a HiLyte Fluor 750 hydrazide. In another embodiment the probe is colloidal gold including gold nanoshell particles. In yet another embodiment, the probe is a tetracycline fluorescence probe having at least one of chlortetracycline, oxytetracycline, and doxycycline.

In certain embodiments, a duration of contacting is at least about 20 seconds, at least about 40 seconds, or at least about 60 seconds. In another embodiment of these methods, an area of a gray, silver, white or translucent spot is an indication of a location of the caries. In a related embodiment of these methods, a size of an area of a gray, silver, white or translucent spot is an indication of an extent of the caries.

In certain embodiments of these methods, the caries with bound probe is detected using a hand-held intra-oral optical device. In another embodiment of these methods, luminescence is detected using an ultra-violet lamp, or a hand-held intra-oral probe attachment of a spectrophotometer and/or optical device.

In another embodiment, the method further involves prior to contacting, detecting a presence of an auto-fluorescence. In another embodiment, the method further involves curing the detected caries by remineralization. In certain embodiments, the caries are detected in a subject that is a mammal. In another embodiment, the subject is a human.

In certain embodiments, the method further involves preparing a photographic image of an area of the caries with bound probe. In another embodiment, the method further includes remineralizing the caries lesion, in which the caries lesion is monitored, and is prevented or reduced.

In another aspect, the invention provides a kit for detecting early stage dental caries in a subject, the kit including a detectable probe that binds to the caries, the kit further having a container, and a positive control tooth sample having an early stage lesion. In another embodiment, the invention provides a kit for detecting early stage dental caries in a subject, the kit including at least one probe selected from the group of: colloidal gold; a fluorescent probe; and a bioluminescent; in which the probe binds selectively to the caries, the kit further having a container, and a positive control tooth sample having an early stage lesion.

In certain embodiments, the kits further include instructions for use with an optical device. In another embodiment, the fluorescent probe in the kit is a tetracycline or a tetracycline conjugate. For example, the fluorescent probe is selected from the group consisting of Indocyanine Green, Doxorubicin, Riboflavin, Chlorophyll, and Porphyrin.

In another aspect, the invention provides a kit for detecting early stage dental caries in a subject, the kit including a detectable probe, an optical device, and a container. In a related embodiment, the further includes a positive control tooth sample having an early stage lesion. In another related embodiment, the kit further includes instructions for use.

In yet another related embodiment, the optical device is at least one device selected from the group of: a hand-held intra-oral light wave detection device, a camera, and a fiber optic optical device. In certain embodiments, the optical detection device further includes an electromagnetic wavelength radiation emitter, wherein a wavelength is generated for excitation of fluorescent probes.

In certain embodiments the probe in the kit is at least one composition selected from the group of fluorescent compositions and bioluminescent compositions. In a related embodiment, the probe is a chemiluminescent composition, for example, luciferase, luciferin, and a mixture thereof. In another related embodiment, the probe is a fluorescent probe, for example, Indocyanine Green, Doxorubicin, Riboflavin, Chlorophyll, and Porphyrin. In yet another related embodiment, the probe is at least one composition selected from the group of Qdot, colloidal gold, and bismuth.

In certain embodiments, the probe is a unit dose. In another embodiment, the kit further includes an applicator for the probe. The applicator is, for example, a spray, a soak in a bite wing plate, and a gel extruded from a compressible tube.

### BRIEF DESCRIPTION OF THE DRAWING

FIG. 1 is a set of drawings showing the nature of a “white spot” located within 100 micrometers (one-half of the thickness of enamel from the surface of the enamel), an early stage dental caries that cannot be detected by conventional means because X-ray detection requires that the lesion to be larger (400-500 micrometers).

FIG. 2 is a set of photographs showing an optical device used in embodiments of the invention for detecting the probes that are bound to early stage caries lesions in a tooth or teeth. The photographs show a light source (1) for illuminating a tooth to observe an early stage caries lesion having bound to the caries a probe. A camera (2) as provided herein captures the image of the tooth with an early stage caries lesion and bound detectable probe. A computer (3) controls the emitting light source and further stores observed data. A stage (4) is provided for holding the sample, i.e., synthetic tooth, bovine tooth, or slice of enamel, having an early stage caries lesion for illumination. An optical fiber (5) transmits and focuses the electromagnetic light waves emitted by light source (1) and direct the waves at an area on the tooth that is in stage (4).

FIG. 3 is a photograph showing absorption of light on a synthetic tooth preparation having an early stage caries lesion to which a bismuth probe has been bound.

FIG. 4 is a photograph showing fluorescence of an early stage caries lesion in a synthetic tooth preparation to which a Doxorubicin probe has been bound.

FIG. 5 is a photograph showing fluorescence of an early stage caries lesion in a synthetic tooth preparation to which a Riboflavin probe has been bound.

FIG. 6 is a photograph showing fluorescence of an early stage caries lesion in a synthetic tooth preparation to which a Chlorophyll A probe has been bound.

FIG. 7 is a photograph showing fluorescence of an early stage caries lesion in a synthetic tooth preparation to which a Porphyrin probe has been bound.

FIG. 8 is a photograph showing bioluminescence of an early stage caries lesion in a synthetic tooth preparation to which a luciferase and luciferin probe has been bound.

### DETAILED DESCRIPTION

New possibilities in quantitative caries detection are currently on the horizon with the development of intra-oral optical devices. While the current industry-accepted standard for caries detection is a combination of clinical and radiographic examination, the intra-oral optical device has potential to detect a very small optical property change which otherwise may be missed by the human eye. Such a development would also spare patients from exposure to the radiation associated with radiographs, could reduce labor-intensive clinician time in detecting very early stage caries, and might even make detection possible for caries that might otherwise go undetected until a later stage.

Demineralization on an enamel surface of a tooth results from the presence in the oral cavity of acid and bacteria, and these agents initiate dental caries. Hence a molecule capable of binding as a positive/negative ion in the region of an early stage caries, i.e., an area of demineralization, is without limitation a potential probe for the methods and devices herein.

Examples of classes of useful probes have additional properties with respect to light: probes that provide fluorescence of the excitation light; proves that generate fluorescence without excitation by light, viz., bioluminescent probes such as the system of luciferase/luciferin; and probes that absorb illuminating light such as Bismuth, Gold colloid.

A slight difference of at least one of the standard optical properties (pattern of reflectance curves, color readings, Scattering/Absorption coefficients, or any other optical data) was sought herein in order to distinguish a caries lesion, compared to a sound tooth structure, and a handheld unit could be programmed such that it is designed to take accurate optical properties of caries lesions in patients' oral cavities. Surprisingly, these differences were in fact detected experimentally using the classes of probes described in examples herein. Therefore, using an optical device to detect potential changes in early lesions, such as an extent of binding of a probe capable of fluorescence or auto fluorescence using another class of agent, is described herein as a tool for detecting early stage caries.

The wavelength of illumination (excitation) and emission for fluorescence are optimized for each probe. A standard optical device can be modified for suitable use. Illuminating light is used on an entire tooth surface, for example, by scanning the surface with the beam of illuminating light. Scanning is particularly important for detetion of an interproximal area. Further the examples herein were found to show that angle of illumination is also important, such that illumination in an orientation parallel to the direction of the enamel prism was particularly effective in detection of probe.

For the optical device to be used with various of the probes herein, detection is best obtained using a camera, for example, a small camera such as a fiber optic camera. Additional criteria with respect to the optical device are size of diameter of beam of illuminating light that directly contacts the tooth (a smaller beam generates superior data); diameter of camera for detection of probes that absorb light (a smaller diameter is superior, similarly to considerations of use of an endoscope); diameter of camera for detection of probes that are fluorescent (smaller is superior, similarly to considerations involved in use of an endoscope); and, illumination capable of scanning and a camera capable of recording a scanning light.

Further, many recent studies relating to caries detection indicated that there is no precise optical method to detect an interproximal caries lesion. Although detection based on “near infrared” (NIR) is a possible technique to capture images of an interproximal lesion, a substantial number of false positive hits were found to have been obtained, and therefore this approach remains far from use in the clinic. Surprisingly, however, compositions were discovered as shown in examples herein, that bind specifically to caries and can be detected using an optical device.

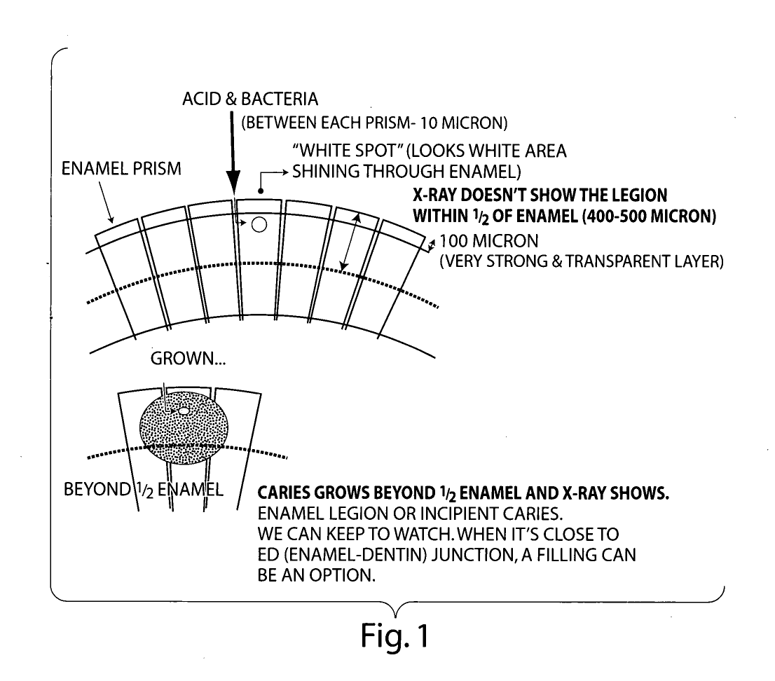

The phrase, a “white spot” as used herein refers to a very early stage of decay that starts inside of enamel, within 100-150 μm or less of the surface of the enamel. See FIG. 1. Bacteria and acid further penetrate through the space of enamel prism (10 μm space between each enamel prism), and demineralization is initiated there and proceeds towards the surface of enamel. It is envisioned herein that detection of a white spot at an early stage of a lesion, using the methods and techniques provided herein of detection leads to consequent possibility of methods for remineralization. These treatments would be a substantial contribution to improved dental health and reduction of costs.

As used herein, the word “probe” refers to a detectable composition that specifically or preferentially binds a caries lesion. The term includes without limitation a stain, a marker, and a dye capable of binding to a caries in the enamel layer of a tooth. In certain embodiments, the probe is a fluorescent composition, for example, tetracycline, Hylight Fluor, Qdot, Indocyanine Green, Doxorubicin, Riboflavin, Chlorophyll, or Porphyrin. In general the fluorescent composition bound to enamel is detected by illuminating the treated tooth at an excitation wavelength, and detecting an area of light emission at an emission wavelength. In an alternative embodiment, the probe is a bioluminescent composition, for example, luciferase and luciferin or aequorin.

In an alternative embodiment, the probe is a composition that absorbs light, for example, bismuth, or colloidal gold. In general, light absorbent compositions are detected by illuminating an area of interest, for example, a tooth with a caries lesion, and detecting an area or region of the tooth that absorbs a specific wavelength of light, such as, absorbance of near infra red (NIR) light.

Gold nanoparticles have been designed that strongly absorb light in the NIR as shown in Gobin et al., Lasers in Surgery and Medicine 37: 123-129 (2005). The gold nanoparticles were used with NIR to provide solder welds in wound-healing research, known as laser-tissue welding and laser-tissue soldering, in a rat skin wound-healing model. Various roles for gold nanoparticles are described by Mazzola, L. in Nature Biotechnology (21(10): 1137-1143, 2003), including molecular detection assays, localized payload delivery, tissue ablation triggered by a secondary mechanism such as light activation, and separation.

The gold nanoshell synthesis in Gobin et al. uses basic reduction of tetraethyl orthosilicate, followed by reaction of the silica core nanoparticles with (3-aminopropyl)triethoxysilane (APTES, Sigma-Aldrich, St. Louis, Mo.), and amine groups on the surface of the core allow for deposition of gold colloid. Commercially available gold particles (Auroshell™) are commercially available from Nanospectra Biosciences, Inc. (Houston, Tex.), and from Purest Colloids (MesoGold®; Westampton, N.J.). Examples herein use Colloidal gold total protein probe (BioRad, Hercules, Calif.), however it is envisioned that any commercially available colloidal gold preparation would function similarly in detection of early-stage caries.

Tetracycline in addition to its well-known importance as an antibiotic, is a fluorescence incident agent for photometry, for example, for labeling for bone development/formation. Tetracycline however produces tooth discoloration, referred to as “tetracycline teeth” in dentistry. Tetracycline binds to newly formed bone or tooth at the interface and the resultant binding is observed as a line or dot of fluorescence. The phrase, “tetracycline fluorescence” as an agent that binds to newly formed bone or teeth, is capable of fluorescence when illuminated at a pre-determined wavelength of light, and includes, without limitation, all of the members of the tetracycline family as well as additional compositions such as the gold compounds, quantum dot compounds, HiLyte fluor 750 hydrazide compounds, and any other compounds that share the functional attributes of binding to newly formed bone or teeth and emitting fluorescence or other optical or physical signal upon illumination at a stimulating wavelength.

Indocyanine Green (ICG) is a tricarbocyanine dye that upon excitation, emits lights at about 800 nm, about 820 nm, about 840 nm or at about 860 nm. ICG is commercially available from H.W. Sands Corp. (Jupiter, Fla.) and has been used in infrared photography, the preparation of Wratten filters, and as a diagnostic aid for blood volume determination, cardiac output, or hepatic function. The properties of ICG are described in Landsman et al. (J. Appl. Physiol., 40:575-583, 1976).

Doxorubicin (also known as adriamycin or hydroxyldaunorubicin) is a DNA-interacting cancer drug widely used in chemotherapy. A chemotherapeutic dose of Doxorubicin is in a range of about 60 to 75 mg/m². Doxorubicin is fluorescent and emits light at wavelengths of, for example, about 550 nm, 600 nm, or 650 nm and this property has been used in cell biology research for the measurement of drug efflux pump activities and intracellular localization of various multi-drug resistance proteins, at much lower concentrations than the chemotherapeutic dose. Doxorubicin is commercially available from Sigma-Aldrich (St. Louis, Mo.).

Riboflavin (vitamin B₂) is an easily absorbed micronutrient with a role in a wide variety of cellular processes, for example, energy metabolism. Riboflavin is an easily absorbed, water-soluble micronutrients that support energy production by aiding in the metabolism of fats, carbohydrates, and proteins. Riboflavin is also needed for red blood cell formation and respiration, antibody production, and for regulating human growth and reproduction. Riboflavin functions as antioxidants by scavenging damaging particles in the body known as free radicals. Riboflavin is important for healthy skin, nails, hair growth and general good health, including regulating thyroid activity.

As Riboflavin is water soluble, any excess is not stored but is excreted generally in the urine. In general, Riboflavin has no known toxic dose. The minimum daily recommended dose ranges from 1 mg to 2 mg as a dietary supplement, while a typical therapeutic daily dose ranges from 50 mg-100 mg. Substantially less of Riboflavin is needed in the methods herein for contacting a surface of a tooth. Riboflavin is commercially available from Sigma-Aldrich (St. Louis, Mo.) and is fluorescent, emitting light at a wavelength of, for example, about 450 nm, about 550 nm, about 650 nm, or about 750 nm. The properties of Riboflavin are described in Du et al. (Photochemistry and Photobiology, 68:141-142, 1998).

Chlorophyll A is a green photosynthetic pigment that emits light at a wavelength of, for example, about 600 nm, about 700 nm, or about 800 nm. Chlorophyll A is commercially available from suppliers such as Sigma Chemical (St. Louis, Mo.) and Turner Designs (Sunnyvale, Calif.). As Chlorophyll is a normal part of a regular human diet, it has no known toxicity.

Porphyrin is a heterocyclic macrocycle made from 4 pyrrole subunits linked on opposite sides through 4 methine bridges (═CH—). The extensive conjugated structure of Porphyin makes the compound chromatic, i.e., fluorescent at a wavelength of, for example, about 600 nm, or about 650 nm, or about 700 nm. Porphyrin is commercially available from Sigma-Aldrich (St. Louis, Mo.). Porphyrin is associated with hemoglobin and myoglobin, which are components of an animal based diet, and is therefore a normal part of a regular human diet, thus it also has no known toxicity.

For bioluminescent probes, excitation energy is supplied by a chemical reaction rather than from an incoming source of light. Luciferin and luciferase are an example of a substrate and its associated enzyme, which catalyzes a light-producing reaction, i.e. bioluminescence, and adenosine triphosphate (ATP) is involved in this reaction. Light is emitted (for example at about 500 nm, at about 550 nm, or at about 650 nm) when luciferase is exposed to the appropriate luciferin substrate in the presence of ATP, and photon emission is detected by a light sensitive apparatus such as the optical devices described herein. Luciferase and luciferin have been widely used, for example, to observe biological processes and stages of infection, and are commercially available from Sigma-Aldrich (St. Louis, Mo.).

Further examples of bioluminescent compositions are green fluorescent protein (GFP) and aequorin. These are bioluminescent compositions are isolated from the jellyfish Aequorea victoria. When a calcium ion binds to aequorin, the complex breaks down into apoaequorin and a luminescent composition, which emits blue light (at about 466 nm). Synthetic aequorin is commercially available from Sealite, Sciences (Bogart, Ga.) as AQUALITE®. GFP emits light in the lower green portion of the visible spectrum (at about 490 nm to about 570 nm). Synthetic GFP is commercially available from Clontech (Mountain View, Calif.).

The composition known as “quantum dot” consists of a solution of nanometer-scale (roughly protein-sized) atom clusters, exemplified by Qdot® available commercially from Invitrogen (Carlsbad, Calif.). The clusters contain combinations of materials, such as a combination of alkali metals (Li, Na, K, Rd, Cs and Fr), alkaline earth metals (Be, Mg, Ca, Sr, Ba and Ra), transition metals (Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au and Hg), lanthanides (La, Ce, Pr, Nd, Pm, Sm, Eu, Gd, Tb, Dy, Ho, Er, Tm, Yb and Lu) and actinoids (Ac, Th, Pa, U, Np, Pu, Am, Cm, Bk, Cf, Es, Fm, Md, No and Lr) on a silica- or silicone-based core.

Quantum dot preparations have been developed for use as fluors by binding to samples followed by illuminating with light in the UV spectrum. The quantum dot preparations exhibit large molar extinction coefficients, high photostability and strong and size-dependent tunable emission. The tunable aspect of the emission peak is adjusted to be infrared, far-red and red light that accordingly binds to dental enamel by virtue of the commercially available preparations having different combinations of metals and different sizes of particles. In addition, dot particle preparations are available with an overall negative charge or a positive charge, depending on the combination of metals.

It is shown herein that a quantum dot preparation selectively binds to decalcified enamel but not healthy electronically neutral enamel, due to the electronic charge.

Furthermore, quantum dot can be conjugated to any of the small compounds described herein, such as tetracycline, calcein (a fluorescent stain used to label intact and living cells; Invitrogen) and their derivatives, that have an affinity to decalcified enamel. These conjugates form an “enamel affinity quantum dot” preparation. Decalcified enamel is then detected using the enamel affinity quantum dot as enamel-translucent fluorescence. Alternatively, quantum dots that bind to decalcified enamel are detected by dichroism, such as fluorescence detected circular dichroism.

Yet another example of a useful composition in the present application is HiLyte Fluor 750 hydrazide, which is a commercially available fluorescence dye that is used as a probe for colloidal gold (AnaSpec, Inc., San Jose, Calif.). HiLyte Fluor 750 hydrazide is a carbonyl-reactive fluorescent labeling dye. It can be used for labeling glycoprotein such as horseradish peroxidase (HRP). HiLyte Fluor 750 hydrazide is the longest wavelength carbonyl-reactive HiLyte Fluor dye currently available. Its fluorescence emission is at about 782 nm, well separated from commonly used far-red fluorophores such as HiLyte Fluor 647, HiLyte 680 or allophycocyann (APC), facilitating multicolor analysis.

The dose of the probe depends on the species of the mammal, the body weight, the age and the individual condition, individual pharmacokinetic data, and the mode of administration. The probes herein are suitable for contacting or applying to a mammalian tooth (humans and high value animals) for the detection of an early stage caries lesion to which the probes herein bind, including an amount of a probe of the present methods or a pharmaceutically acceptable salt thereof, which is effective for this detection. The probes according to the methods are those for oral contact or application to a mammalian tooth (humans and high value mammals) that include an effective dose of the probe, alone or together with a significant amount of a pharmaceutically acceptable carrier or buffer.

A solution concentration of the probe of the present methods or a pharmaceutically acceptable salt thereof to be contacted to a tooth surface, for example an adult human tooth surface, is for example, from approximately 1 ng/ml to approximately 100 ng/ml, from approximately 100 ng/ml to approximately 500 ng/ml, from approximately 500 ng/ml to about 1 μg/ml, from approximately 1 μg/ml to approximately 50 μg/ml, and from approximately 50 μg/ml to approximately 500 μg/ml. Predictive dental doses for children may be significantly lower, for example one-half to one-tenth.

A longstanding need in dental medicine is detection of an early stage caries lesion. Compositions herein have not previously been considered as probes for detection of a carious lesion, for example, at a stage associated with initial events such as early demineralization. Another longstanding need is detection of an interproximal lesion, i.e., a lesion located on a surface between teeth. Detection of interproximal lesions at an early stage, i.e., located within one-half of the depth of enamel, using X-ray (Bite wing) or by visual clinical inspection, has not previously been possible.

An optical device suitable for detecting the caries with bound probes according to the methods herein includes optical components similar to those found in endoscopes. These components include either a rigid or flexible tube containing one or more optical fiber systems, the tube having a channel for mechanical devices, such as a light delivery system used, for example, to illuminate an object under inspection, in the case herein, a surface of a tooth. In certain embodiments, the optical device further includes a device that emits electromagnetic wavelength radiation. Such a device is described in Bukosky et al. (U.S. Pat. No. 6,076,948, issued Jun. 20, 2000).

In one embodiment, the light delivery system includes a light source located outside the oral cavity, with the light directed onto the tooth via an optical fiber system. Alternatively, the optical device contains a built-in light source, such as an LED. In certain embodiments, the optical device includes a lens system to transmit images to the user. The user can control the wavelength of the transmitted source, for example, to transmit light suitable for excitation of a fluorescent probe. An example of a hand-held intra-oral light wave detection device is the SharpVision ZE-411 oral endoscope (Sharp Vision Co. Ltd., Guangdong, China).

In certain embodiments, the optical device is an ultra-violet (UV) lamp. UV refers to electromagnetic radiation with wavelengths in the range of about 10 nm to about 400 nm. The UV wavelengths from about 345 nm to about 400 nm produce a “blacklight” effect, i.e., this range of wavelengths causes certain compositions to fluoresce. UV lamps are commercially available from Unilam Co, LTD. (South Korea).

In other embodiments, the optical device is a spectrophotometer. As used here, a spectrophotometer refers to a device for measuring light intensity, i.e., the device can measure intensity as a function of the color, or more specifically, the wavelength of light. In certain embodiments, the spectrophotometer is used to detect the fluorescent probe bound to an early caries lesion in a tooth. Spectrophotometers are commercial available from Hitachi Ltd. (San Jose, Calif.). In a related embodiment, the spectrophotometer is a hand-held spectrophotometer such that a technician can measure intra-orally, eletromagnetic light waves (emission or absorbance) from the probes bound to the early stage caries on a tooth. Hand-held spectrophotometers are commercial available from Konica Minolta (Chiyoda-ku, Tokyo).

In other embodiments, a probe fluoresces at a wavelength within the spectrum of visible light, and is thus detected using a camera to photograph the tooth having an early stage caries lesion to which the probe is bound. As used herein, a camera refers to a device used to capture images as still photographs or as sequences of moving images. A camera suitable for detection of the probes herein is commercially available from Texas Instruments (Dallas, Tex.).

An optical fiber such as for use in fiber optics is within the scope of the optical devices herein. The optical fiber includes a glass or plastic fiber that transmits light along its length by total internal reflection. The fiber includes a core surrounded by a cladding layer, in which one or more layers of material of lower refractive index are in contact with a core material of higher refractive index. Optical fibers are used herein as light guides, to illuminate an area or locus of a dental surface, including an interproximal surface between teeth. Optical fibers can include a coherent bundle of fibers, often along with lenses.

Fiber optics are known in previous dental use, for example, in light-polymerization of a composition for dental filling. The hardening process uses blue light with a wavelength of approximately 450 nm fed from a hand-held light source via a fiber rod or fiber taper to the tooth being treated (SCHOTT North America Inc., Southbridge, Mass.). These devices are readily adaptable to the kits and methods herein.

For the kits herein, various methods can be used to contact a tooth surface with any one or more of the probes. For example, a thin lamella or matrix can be coated with probe, and the matrix can be applied to the tooth. The matrix can be a thin strip of paper, plastic tape, or any other convenient applicator. Alternatively an injection type of syringe having a barrel containing a solution of the probe can be used to apply a small volume of the probe as a soak. The interproximal region can be made more accessible by pre-treating the area with a wedge to widen the space between two or more teeth.

After probe has been contacted to a tooth or teeth and prior to visualizing with an optical device, the area is rinsed at least once with water, to remove excess probe.

A further example of a dental use of optical fibers includes lighting of handpieces. Dental instruments typically include a light source to illuminate the treatment area. A light guide is built into the instrument handpiece for this purpose (SCHOTT North America Inc., Southbridge, Mass.), and such instruments can be adapted to the purposes herein.

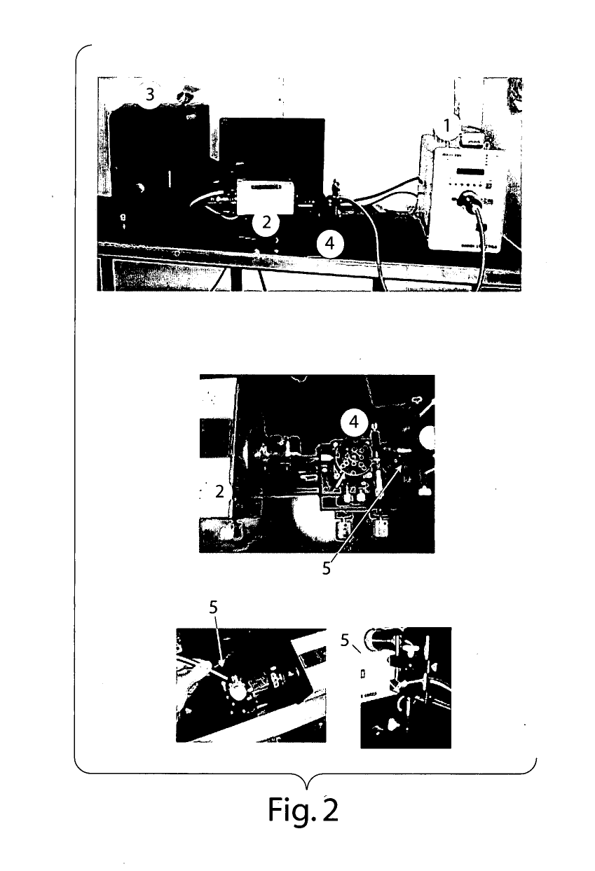

FIG. 2 shows an optical device used in certain embodiments of the invention for detecting a probe that is bound to an early stage caries lesion in a slice or sample of a tooth pr an experimental tooth. The tooth for detection of an early stage caries lesion using binding of a probe is placed in stage 4. A light source 1, a MAX301 xenon light (Asahi Spector, China), illuminates an area of the tooth at a wavelength that allows for detection of any binding of the probe, i.e., illuminates with light having a wavelength of absorption or emission. In certain embodiments, an optical fiber 5 (Olympus, Melville N.Y.) transmits and focuses the electromagnetic light waves emitted by light source 1 and direct the waves at an area on the tooth that is in stage 4. The optical fiber 5 is modified to direct the electromagnetic light waves to form a spot illumination, using a silicon cap and paper wrapping. A camera 2, a MC285SPD-L0B0 camera (Texas Instruments, Dallas, Tex.), captures the image of the detectable probe and transmits it to computer 3, Optiplex 20 1L (Dell Inc., Round Rock, Tex.). A computer 3 uses Capture eBase (Solution Systems, Inc., Rolling Meadows, Ill.), a software program for controlling light source 1, for example, the software can control the wavelength of light source 1, for example, to transmit light suitable for excitation of the probe.

Remineralization uses compositions and methods that are well-known in the dental arts, for example, a commercially available product, Enamelon, which is a toothpaste having soluble calcium phosphate supplied directly to teeth. Enamelon further contains fluoride, and comprises a white toothpaste with calcium and a blue toothpaste with phosphate and fluoride. Squeezing the tube produces side-by-side stripes to produce a remineralizing treatment. Alternatively, one or more of remineralizing gels are applied at a dental visit, for example, treatment about once per month with a topical gel containing 100-150 ppm fluoride, for example, 2.72% acidulated phosphate fluoride, and 2% neutral sodium fluoride. Caution is taken to provide doses that are well below a level of toxicity, and to assure that the subject does not swallow the gel.

The invention now having been fully described is exemplified by the following examples and claims, which are exemplary only and are not intended to be construed as further limiting. The contents of all references cited are hereby incorporated herein by reference.

### EXAMPLES

### Example 1

### Detection of Fluorescence in Extracted Teeth and Correlation with White Spots

Enamel samples each containing a portion of extracted teeth were analyzed to identify and obtain those having at least one “white spot”. White spots were divided into two stages: visible white spots, and dull white spots on the enamel surface. Teeth were illuminated and examined for evidence of autofluorescence. No particular autofluorescent phenomena were observed under the ultraviolet light. The data show that white spots and other portions of teeth do not exhibit autofluorescence, therefore use of fluorescent agents to detect white spots is facilitated by this observation.

Samples of extracted teeth were incubated in Tetracycline solution (1 mg/ml) for 60 seconds, and were then washed with phosphate buffered saline (PBS). The samples were observed under ultra-violet (UV) light at 260 nm (Ultra Violet lamp SB-4W). In addition, fluorescence was determined using a hand-held probe attached to an Olympus spectrophotometer. It was observed for these teeth that a clear locus of bright yellow fluorescence due to bound tetracycline was located in the area corresponding to the previously identified white spot.

### Example 2

### Histological Analysis

Teeth having white spots are analyzed by electron microscopy laterally, and following obtaining transverse sections, and regions of fluorescence are correlated and further analyzed histologically. In this manner the identity of the sites of fluorescence with early stage carious lesions is established.

### Example 3

### Detection of Caries in Bovine Teeth by Gold Colloidal Probe

Bovine teeth were cleaned by a process of soaking for 10 to 30 seconds in 10% hydrochloric acid. A model test system for caries was established by etching select surfaces with dental etching gel, non-silica 10% phosphoric acid etch gel, for 30 seconds, and other samples were retained in absence of etching to serve as a negative control.

Colloidal Gold Total Protein Stain (BioRad, Hercules, Calif.) was applied to each of the test samples and to the negative control samples, by soaking for 20-30 seconds; samples were then rinsed with distilled water. Samples were further stained with Silver Stain Plus kit (BioRad), derived from a method developed by Gottleib and Chavko (Anal Biochem 165: 33, 1987). All tooth samples were then illuminated with NIR light, for absorbance.

Results obtained indicated that the test samples that had been etched prior to soaking showed areas of silver-gray coloration, while the negative control (not etched) did not show any areas of this color. These data show that NIR illumination of tooth samples contacted with a Gold probe detects early stage caries, including interproximal caries lesions.

### Example 4

### Detection of Caries in Human Subjects

A dental patient is contacted via the buccal or lingual cavity with a solution of a tetracycline, such as a 1 mg/ml solution used as a gargle for 30 seconds. After extensive rinsing, the buccal or lingual cavity is illuminated with UV light, and appearance and location of any fluorescent spots, respectively, are probed with a hand-held attachment for a spectrophotometer. Areas of fluorescence or gray spots are photographed.

A dental patient is contacted via the buccal or lingual cavity with a solution of a colloidal gold, such as the BioRad Total Protein Stain, catalog number 170-6527, as a gargle for 30 seconds. After gargling and extensive rinsing with water, the Gold treatment is followed by a 20-30 second gargle with Silver stain Plus (Bio-Rad). Then the buccal or lingual cavity is illuminated with near infra-red (NIR) light, and appearance and location of areas of gray-silver staining are probed with a hand-held attachment for a spectrophotometer. Areas of stain are photographed.

### Example 5

### Remineralization in Human Subjects of Early Stage Caries Detected by Optical Properties

Following detection, procedures for remineralization are initiated for those locations having early stage caries. For example, fluoride ions are introduced by use of a topical gel or toothpaste designed for this purpose, into the lesion. The remineralization treatments leading to restoration of integrity of the enamel induce precipitation of calcium and phosphate on crystals in the enamel that are partially demineralized.

### Example 6

### Assessment of Detection Probes Using Bovine Samples

Bovine teeth are obtained and sliced to obtain enamel samples, excluding the dentin layer, are fabricated from the bovine teeth. A de-mineralized area is prepared by etching an area of the sliced enamel samples. The sliced enamel surface containing a de-mineralized area is contacted with a series of concentrations of each of the probes. The presence of the bound probe on the surface is observed by illuminating over a varying set of different wavelengths of excitation, followed by observing emission. Further, absorbance of the illuminating wavelengths, is detected. Optical observations are obtained directly by eye, by spectrophotometer, or by camera, photographing the tooth or indirectly by having the data sent from a probe on an optical device to an imager on the optical device.

### Example 7

### Assessment of Detection Probes Using Interproximal Models of Human Extracted Teeth

Interproximal models of extracted human teeth (molars and premolars) are fabricated using silicon impression materials to produce tooth preparations. Experimental interproximal enamel caries (500 nm depth and 1.5 mm width) are prepared using areas of interproximal contact regions, in each of the tooth preparations. The preparations of the synthetic caries are assessed by radiographic films (bitewings) and a microscope.

In an initial contact method, a cotton ball is saturated with the detection probe, and placed in contact with the region of the interproximal enamel caries. The bound probe is observed by illuminating over a varying set of different wavelengths of excitation, followed by observing fluorescent emission. Further, absorbance of the illuminating wavelengths, is detected as appropriate for each probe. Optical observations for each probe are shown in Table 1 below.

TABLE 1
Properties of detection probes

| | | | Excitation/ | | |
|---|---|---|---|---|---|
| | | | Absorbance | Emission | |
| Detection probe | Composition | Detection | (nm) | (nm) | Detection |
| Bismuth | Metal | Absorbance | Absorption | | Good |
| Gold colloid | Metal colloid | Absorbance | 530 | | Weak |
| Doxorubicin | Anti-cancer | Fluorescence | 480 | 630 | Good |
| | medicine | | | | |
| Riboflavin | Vitamin B₂ | Fluorescence | 450 | 550-700 | Good |
| Chlorophyll A | Chlorophyll | Fluorescence | 614 | 670-900 | Good |
| Indocanine Green | Dye | Fluorescence | 800 | 835 | Weak |
| Porphyrin | | Fluorescence | 600 | 700 | Good |
| Luciferase/ | Organic enzyme | Chemical reaction | | 630 (PH) | Good |
| Luciferin | and protein | fluorescence | | dependent | |
| Qdot | Nanodot | Fluorescence | | | Good |
| Hylight Flour | Small molecular | Fluorescence | | | Good |
| | weight compound | | | | |

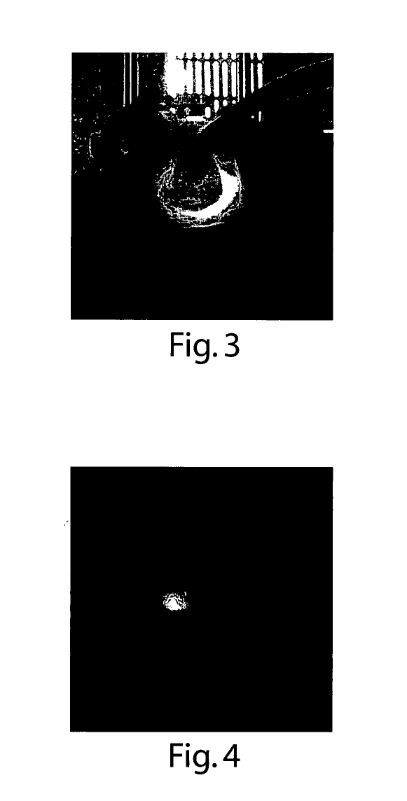

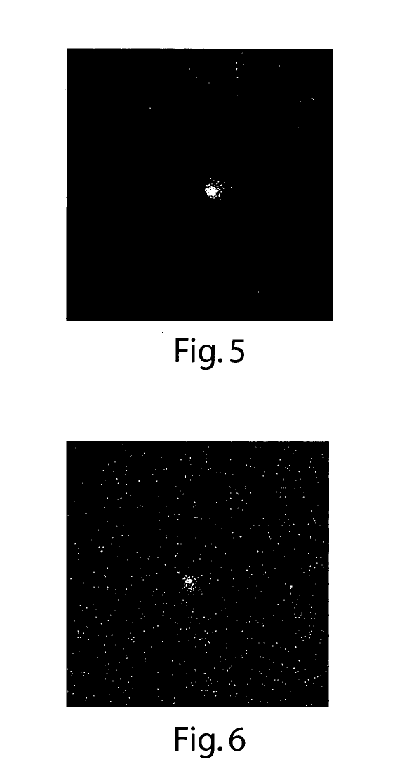

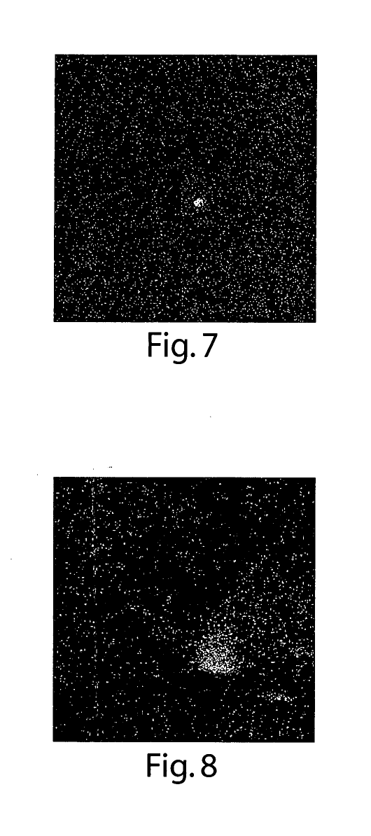

Each tooth preparation having an interproximal enamel caries and bound probe was illuminated and photographed. FIG. 3 is a photograph showing absorption of light on a tooth preparation with an early stage caries lesion to which a preparation of a bismuth probe has been bound. FIG. 4 is a photograph showing fluorescence of an early stage caries lesion in a tooth preparation to which a preparation of a Doxorubicin probe has been bound. FIG. 5 is a photograph showing fluorescence of an early stage caries lesion in a tooth preparation to which a preparation of a Riboflavin probe has been bound. FIG. 6 is a photograph showing fluorescence of an early stage caries lesion in a tooth preparation to which a preparation of a Chlorophyll A probe has been bound. FIG. 7 is a photograph showing fluorescence of an early stage caries lesion in a tooth preparation to which a preparation of a Porphyrin probe has been bound. FIG. 8 is a photograph showing bioluminescence of an early stage caries lesion in a tooth preparation to which has been bound a probe preparation having luciferase and luciferin.

### Example 8

### Optimization of Variables

Intensity of the illumination light, and the size of the illumination light beam are varied, and data are observed, for each probe. The concentration for each detectable probe is varied to obtain an optimum concentration, having a time for soak for each detectable probe that is suitable for dental use. In general, determined using the systems described in examples above, duration of contacting suitable for dental use is about 20 seconds, about 40 seconds, or about 60 seconds. The optical properties of luciferase and luciferin at various pHs is determined to obtain good fluorescence properties. Ability of the detectable probes to bind to the surface of a tooth having different occlusal cavity conditions, i.e., plaque, gingival, calculus, soft tissue, and tightness of interproximal contact, are determined using the systems described in examples above.

What is claimed is:

1. A method for detecting an early stage dental caries in a subject, the method comprising:
contacting a caries lesion which is at an early stage, selectively binding an optically detectable probe to the caries; and
detecting the caries having bound probe using an optical device.

2. The method according to claim 1, wherein detecting the selective binding further comprises a step selected from the group of: contacting a tooth with a fluorescent probe, wherein the fluorescent probe is selected from the group of tetracycline, Hylight Fluor, Qdot, Indocyanine Green, Doxorubicin, Riboflavin, Chlorophyll, and Porphyrin, and illuminating the tooth at an excitation wavelength, wherein diagnosing is detecting a area of light emission at an emission wavelength; contacting the tooth with the probe, wherein the probe is luciferase and further contacting the tooth with luciferin and ATP, wherein diagnosing is detecting a area of bioluminenesce; contacting the tooth with a colloidal gold, wherein diagnosing is detecting a area of absorbance of near infra red (NIR) light; contacting the tooth with a quantum dot composition probe, wherein diagnosing is detecting fluorescence or fluorescence-detected dichroism; contacting a tooth with a probe that is a conjugate of a quantum dot composition, wherein the conjugate is attached to a second agent selected from the group of a tetracycline, bismuth, a colloidal gold or the like, followed by detecting fluorescence or fluorescence-detected dichroism; and contacting a tooth with colloidal gold, wherein diagnosing is detecting fluorescence with a HiLyte Fluor 750 hydrazide.

3. The method according to claim 1, wherein the early stage caries is prior to cavitation or advanced demineralization.

4. The method according to claim 2, wherein detecting the caries is observing by photometry.

5. The method according to claim 2, wherein the caries with selectively bound tetracycline probe is observing a white spot.

6. The method according to claim 2, wherein the caries with the selectively bound quantum dot probe is a spot of enamel-translucent fluorescence.

7. The method according to claim 3, wherein a gray, silver, white or translucent spot is diagnosed on the surface of enamel, or within an underlayer of about 50 to about 100 micrometer of the surface.

8. The method according to claim 1, wherein the caries is interproximal.

9. The method according to claim 1, wherein prior to contacting, interproximal regions are accessed by at least one method selected from the group of: inserting a spacer; and delivering the probe into the interproximal area using a metal or plastic strip containing the probe.

10. The method according to claim 9, wherein the conjugate comprises a quantum dot composition or a HiLyte Fluor 750 hydrazide.

11. The method according to claim 9, wherein the colloidal gold comprises gold nanoshell particles.

12. The method according to claim 9, wherein the tetracycline fluorescence probe comprises at least one of chlortetracycline, oxytetracycline, and doxycycline.

13. The method according to claim 9, wherein a duration of contacting is at least about 20 seconds, at least about 40 seconds, or at least about 60 seconds.

14. The method according to claim 4, wherein an area having a gray, silver, white or translucent spot is an indication of a location of the caries.

15. The method according to claim 4, wherein a size of an area having a gray, silver, white or translucent spot is an indication of an extent of the caries.

16. The method according to claim 1, wherein the optical device is a hand-held intra-oral optical device.

17. The method according to claim 4, wherein fluorescence is detected using a device selected from the group consisting of an ultra-violet lamp or a hand-held intra-oral probe attachment, which connects to a spectrophotometer.

18. The method according to claim 1, further comprising prior to contacting, detecting a presence of an auto-fluorescence.

19. The method according to claim 1, further comprising curing the detected caries by remineralization.

20. The method according to claim 1, wherein the subject is a mammal.

21. The method according to claim 1, wherein the subject is a human.

22. The method according to claim 1, further comprising preparing a photographic image of an area of the caries with bound probe.

23. The method according to claim 1, further comprising remineralizing the caries lesion, wherein the caries lesion is monitored, and is prevented or reduced.

24. The method according to claim 1, wherein the optically detectable probe is charged.

25. The method according to claim 2, wherein the fluorescent probe is a tetracycline, the wavelength for illuminating the tooth is about 350 to about 450 nm, and the wavelength for detecting its fluorescence is about 450 to about 600 nm.

26. The method according to claim 2, wherein the fluorescent probe is a Hilyte Fluor, the wavelength for illuminating the tooth is about 720 to about 750 nm, and the wavelength for detecting its fluorescence is about 750 to about 800 nm.

27. The method according to claim 2, wherein the fluorescence probe is a Qdot, the wavelength for illuminating the tooth is about 400 to about 750 nm, and the wavelength for detecting its fluorescence is about 750 to about 900 nm.

28. The method according to claim 2, wherein the fluorescence probe is an Indocyanine Green, the wavelength for illuminating the tooth is about 750 to about 800 nm, and the wavelength for detecting its fluorescence is about 820 to about 870 nm.

29. The method according to claim 2, wherein the fluorescence probe is a Doxorubicin, the wavelength for illuminating the tooth is about 400 to about 500 nm, and the wavelength for detecting its fluorescence is about 600 to about 700 nm.

30. The method according to claim 2, wherein the fluorescence probe is a Riboflavin, the wavelength for illuminating the tooth is about 400 to about 500 nm, and the wavelength for detecting its fluorescence is about 500 to about 700 nm.

31. The method according to claim 2, wherein the fluorescence probe is a Chlorophyll A, the wavelength for illuminating the tooth is about 600 to about 650 nm, and the wavelength for detecting its fluorescence is about 670 to about 900 nm.

32. The method according to claim 2, wherein the fluorescence probe is a Porphyrin, the wavelength for illuminating the tooth is about 550 to about 650 nm, and the wavelength for detecting its fluorescence is about 650 to about 750 nm.

33. The method according to claim 2, wherein the probe comprises a luciferase, luciferin and ATP, wherein wavelength for detecting its bioluminescence is about 600 to about 800 nm.

34. The method according to claim 2, wherein the probe is a colloidal gold, wherein the wavelength for detecting an area of its absorbance is about 500 to about 800 nm.

35. The method according to claim 2, wherein the probe is a bismuth, wherein the wavelength for detecting an area of its absorbance is about 500 to about 800 nm.

36. A kit for detecting early stage dental caries in a subject, the kit comprising a detectable probe that binds to the caries, the kit further comprising a container, and a positive control tooth sample having an early stage lesion.

37. A kit for detecting early stage dental caries in a subject, the kit comprising at least one probe selected from the group of: colloidal gold; a fluorescent probe; and a bioluminescent; wherein the probe binds selectively to the caries, the kit further comprising a container, and a positive control tooth sample having an early stage lesion.

38. The kit according to claim 36, further comprising instructions for use with an optical device.

39. The kit according to claim 36, wherein the fluorescent probe is a tetracycline or a tetracycline conjugate.

40. The kit according to claim 36, wherein the fluorescent probe selected from the group consisting of Indocyanine Green, Doxorubicin, Riboflavin, Chlorophyll, and Porphyrin.

41. A kit for detecting early stage dental caries in a subject, the kit comprising a detectable probe, an optical device, and a container.

42. The kit according to claim 41, further comprising a positive control tooth sample having an early stage lesion.

43. The kit according to claim 41, further comprising instructions for use.

44. The kit according to claim 41, wherein the optical device is at least one device selected from the group of: a hand-held intra-oral light wave detection device, a camera, and a fiber optic optical device.

45. The kit according to claim 41, wherein the optical detection device further comprises an electromagnetic wavelength radiation emitter, wherein a wavelength is generated for excitation of fluorescent probes.

46. The kit according to claim 41, wherein the probe is at least one composition selected from the group of fluorescent compositions and bioluminescent compositions.

47. The kit according to claim 46, wherein the bioluminescent composition is at least one selected from the group of luciferase, luciferin, and a mixture thereof.

48. The kit according to claim 46, wherein the fluorescent probe is at least one composition selected from the group of Indocyanine Green, Doxorubicin, Riboflavin, Chlorophyll, and Porphyrin.

49. The kit according to claim 41, wherein the probe is at least one composition selected from the group of Qdot, colloidal gold, and bismuth.

50. The kit according to claim 36, wherein the probe is a unit dose.

51. The kit according to claim 41, wherein the kit further comprises an applicator for the probe.

52. The kit according to claim 51, wherein the applicator is at least one selected from the group of a spray, a soak in a bite wing plate, and a gel extruded from a compressible tube.
